(19) United States
(12) Patent Application Publication
(10) Pub. No.: US 2003/0137077 A1
(43) Pub. Date: Jul. 24, 2003

(54) Method of fabricating plastic strips and an extruder structure therefor

(76) Inventors: Kevin Lee, Taipei (TW); Justine Chen, Irwindale, CA (US)

Correspondence Address: Kevin LEE, PO Box 82-144, Taipei, TW

(21) Appl. No.: 10/052,749

(22) Filed: Jan. 23, 2002

(51) Int. Cl. B29C 47/88

(52) U.S. Cl. 264/210.2; 264/211.13; 425/324.1

(57) ABSTRACT

In a method of fabricating plastic strips and an extruder structure therefor, a plastic extruder is used to melt plastic or acrylic raw materials and to extrude the same in the form of soft plastic strips, which can be bent by hand to form a shape by following a pattern that is a line or a recess formed in a mold plate. The plastic strip is allowed to cool to form a product with the desired shape.

### BACKGROUND OF THE INVENTION

(a) Field of the Invention: The present invention relates to a method of fabricating plastic strips and an extruder structure therefor.

(b) Description of the Prior Art

Conventionally, in making products or ornaments formed by twisting or winding flexible strips of plastic or acrylic, a plastic injection molding machine is used to directly inject molten material into a pre-disposed mold plate to obtain the required shapes and forms. However, there are the following drawbacks:

1. The process of developing injection molds is relatively long, and the costs are very high. Injection molding is therefore more suitable for mass production of a single product and is otherwise uneconomical.

2. The design of injection molds is subject to the shape and form of the products. Injection molding is not suitable for very complicated designs, or the molded products do not have satisfactory quality.

3. Injection molded products generally have a uniform appearance, which lacks aesthetic quality. Besides, subsequent processing (burr-removing) of the molded products is troublesome.

### SUMMARY OF THE INVENTION

Therefore, the primary object of the present invention is to provide a method of fabricating plastic strips and an extruder structure therefor, in which a plastic extruder is used to melt plastic or acrylic raw materials and extrude the molten raw materials in form of soft plastic strips, which can be bent by hand into a shape by following a pattern line provided in a mold plate. The plastic strip is then cooled to obtain a product with the desired shape or pattern. The invention entails relatively low costs, and is suitable for producing diversified products and products with complicated designs on a small scale.

Another object of the invention is to provide a method of fabricating plastic strips and an extruder structure therefor, in which a mold plate can be pre-formed with a recess having a desired pattern, and the plastic strip can be bent by following the pattern in the mold plate so as to obtain products of a higher precision.

A further object of the invention is to provide a method of fabricating plastic strips and an extruder structure therefor, in which plastic strip products that have relatively lower product precision than injection molded products but that have a more artistic product appearance are obtainable.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

The foregoing and other features and advantages of the present invention will be more clearly understood from the following detailed description and the accompanying drawings, in which,

FIG. 1 is a perspective view of an extruder according to the invention;

FIG. 2 is a schematic sectional view of the extruder according to the invention;

FIG. 3 is a schematic view illustrating how a plastic strip can be bent manually along the contour of a recess formed in a mold; and

FIG. 4 is a schematic view illustrating how a plastic strip can be bent manually along a line on a mold.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

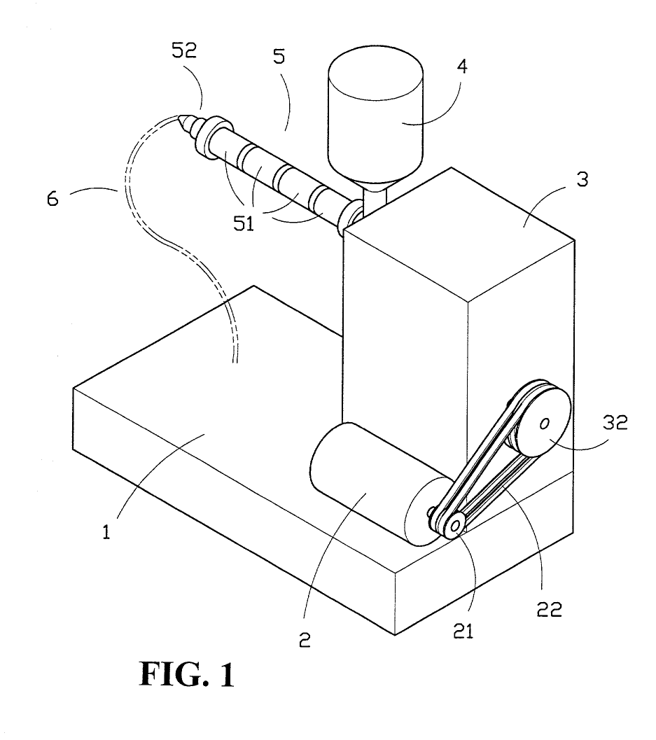

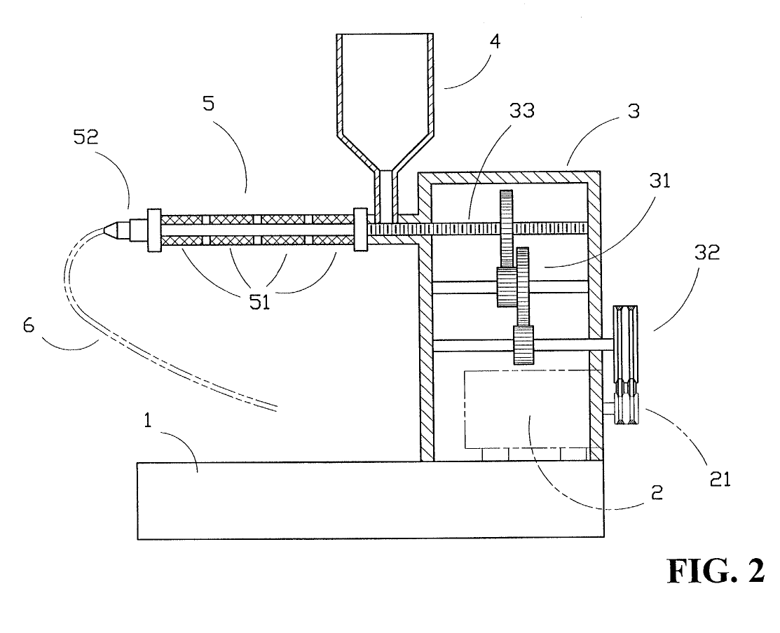

FIG. 1 is a perspective view of an extruder according to the invention. Referring to FIG. 1 in combination with FIG. 2, which is a sectional view of the extruder, the extruder structure according to the invention includes a table 1, a power source 2, a speed change gear box 3, a hopper 4, and a heating pipe 5. The table 1 is a platform that provides a receiving space for other accessory mechanisms. The power source 2 can be a motor, and is disposed on the table 1. The power source 2 includes a drive belt pulley 21 that drives a transmission belt 22 to rotate so as to provide power required for extrusion of the plastic strips. The speed change gear box 3 has a gear set 31 comprising a plurality of gears disposed therein. The gear set 31 has an input end provided with a driven belt pulley 32 that is driven by the transmission belt 22, and an output end provided with a threaded rod 33. The hopper 4 is provided to receive plastic or acrylic materials, and has an outlet disposed at the extend portion of the threaded rod 33 that is adjacent to the speed change gear box 3. The heating pipe 5 is an elongate pipe which has one end connected to the extended portion of the threaded rod 33 that is adjacent to speed change gear box 3, and another end provided with an extrusion nozzle 52. The outer periphery of the heating pipe 5 is provided with a plurality of heating coils 51 for heating the heating pipe 5.

When the power source 2 actuates the drive belt pulley 21 to drive the driven belt pulley 32 via the transmission belt 22, the driven belt pulley 32 drives the threaded rod 33 to rotate via the gear set 31 so that raw material dropped from the hopper 4 is pushed into the heating pipe 5. By adjusting the heating state of the heating coils 51, the heating pipe 5 can maintain a suitable heating temperature according to different materials so that the raw material disposed therein is melted and is extruded via the extrusion nozzle 52 in the form of elongate soft plastic strips 6.

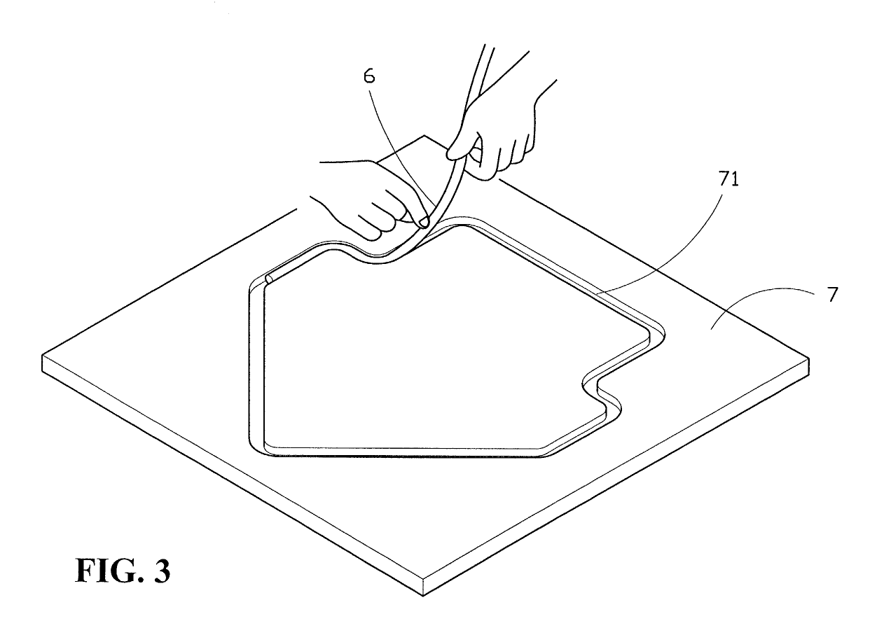

FIG. 3 is a schematic view illustrating how the plastic strip can be bent manually along the contour of a recess pre-formed in a mold. As shown, a mold plate 7 is formed with a recess 72 having a shape corresponding to the shape of a desired product. The operator can bend the plastic strip 6 extruded from the extrusion nozzle 52 along the contour of the recess 71 and allow the same to cool to thereby fix the shape of the plastic strip 6. Such a process requires little costs yet allows for better precision of the product formed. The process is also applicable to relatively large productions.

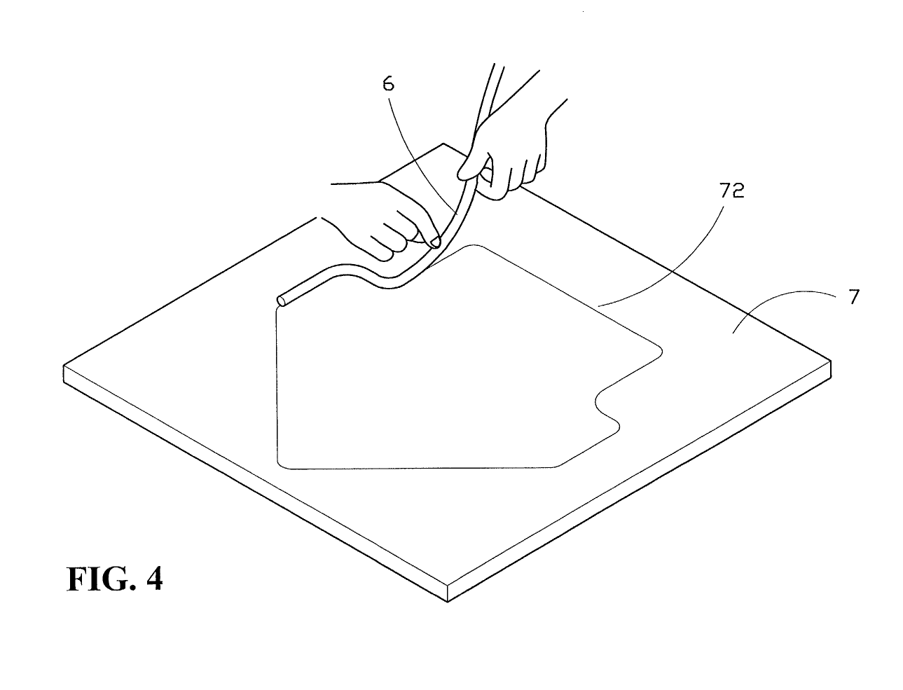

Referring to FIG. 4, the mold plate 7 can be provided with a line 72 of a desired shape, and the operator can bend the plastic strip 6, following the line 72. Although the precision of the product thus formed is not high, the product has a handmade or relatively artistic appearance. Besides, the cost of the mold can be further reduced. This process is suitable for making diversified products on a small scale.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method of fabricating plastic strips, comprising using a plastic extruder to melt plastic or acrylic raw materials for extrusion in form of a soft plastic strip, bending the plastic strip manually by following a pattern provided on a mold, and cooling the plastic strip to thereby form a plastic strip product having the pattern.

2. A plastic strip extruder structure, comprising:
a table for accommodating other accessory mechanisms;
a power source disposed on said table and including a drive belt pulley that brings a transmission belt to rotate therewith for outputting power;
a speed change gear box having a gear set disposed therein, said gear set being formed by a plurality of gears and having an input end provided with a driven belt pulley and driven by said transmission belt, and an output end provided with a threaded rod;
a hopper for receiving plastic acrylic raw materials, said hopper having an outlet disposed at an extended portion of said threaded rod adjacent to said speed change gear box;
a heating pipe which is an elongate pipe and which has one end connected to said extended portion of said threaded rod adjacent to said speed change gear box and another end provided with an extrusion noble, said heating pipe having an outer periphery enclosed by a plurality of heating coils; and
a mold plate being provided with a pattern formed according to shape of a product;
wherein said power source transmits power to said transmission belt to cause said gear set to drive said threaded rod to rotate so that raw materials in said hopper is pushed into said heating pipe, said raw materials being melted by means of heating said heating coils, the molten raw materials being extruded via said extrusion nozzle in form of a soft plastic strip, which can be bent by hand into the shape by following said pattern on said mold plate.

3. The plastic strip extruder structure as claimed in claim 2, wherein said pattern on said mold plate is in the form of a recess.

4. The plastic strip extruder structure as claimed in claim 2, wherein said pattern on said mold plate is in the form of a line.

5. The plastic strip extruder structure as claimed in claim 2, wherein said power source is a motor.
